(19) United States
(12) Patent Application Publication
(10) Pub. No.: US 2002/0147907 A1
(43) Pub. Date: Oct. 10, 2002

(54) System for authorizing transactions using specially formatted smart cards

(76) Inventor: Bruce Ross, San Clemente, CA (US)

Correspondence Address: DENNIS H. LAMBERT, DENNIS H. LAMBERT & ASSOC., 7000 VIEW PARK DRIVE, BURKE, VA, 22015, US

(21) Appl. No.: 09/828,714

(22) Filed: Apr. 6, 2001

(51) Int. Cl. H04L 9/00

(52) U.S. Cl. 713/159; 713/172; 705/65

(57) ABSTRACT

A transaction system includes the use of a fixed data structure that allows multiple point-of-sale systems to recognize and access a transaction card regardless of upper level user interfaces. More specifically, a smart card includes a memory with a defined data file structure, wherein the data file structure includes at least one read only field, at least one encrypted read/write field, and at least one non-encrypted read/write field. The read only field preferably includes at least one of a manufacturer identification field, a card identification field and a theater identification field. The encrypted read/write field preferably includes at least one of a transaction log field, an issue date field, a first dollar value field, a second dollar value field, a first point value field, a second point value field and a ticket storage field. The non-encrypted read/write field preferably includes at least one of a first dollar value display field, a second dollar value display field, a first point value display field, a second point value display field and a user defined field. The smart card is utilized in a transaction system the includes at least one smart card authorization device, a communication interface, and a transaction verification server. The smart card authorization device interacts with a defined data file structure provided on a smart card of the type described above.

### CROSS-REFERENCE TO RELATED APPLICATIONS

This application claims the benefit of U.S. Provisional Application Serial No. 60/195,880, filed Apr. 7, 2000.

### FIELD OF THE INVENTION

The invention relates in general to transaction systems and networks. More specifically, the invention relates to smart cards and smart card authorization systems that provide standardization through the use of a fixed data structure, thereby allowing multiple point-of-sale systems to recognize and access the smart cards regardless of upper level user interfaces. In particular, the invention provides a method of sharing data and/or value between a smart card issued to a user and a point of sale system in an entertainment, theater, restaurant, retail business or other venue.

### BACKGROUND OF THE INVENTION

Systems that allow a user to complete a transaction at a specified location are generally referred to as point-of-sale systems. Point-of-sale systems employ various mechanisms to permit the user to interact with a transaction network to complete a variety of different types of transactions. A sales kiosk or computer terminal, for example, may be employed that allows a user to complete a sales transaction using a credit card, debit card or specialty access cards such as pre-paid gift certificate cards. The sales kiosk or computer terminal generally includes a card reader to read information from the card that is supplied to a transaction network for verification. Upon completion of verification, the transaction is authorized and the sale is completed.

Advancements in technology have led to the development of smart cards. Smart cards include implanted integrated circuitry that permits information to be stored and manipulated on the card as well as read from the card. Most smart cards, for example, utilize electrically erasable programmable memory (EEPROM) to permit storage of data on the smart card. The use of smart cards enables a greater degree of flexibility and enhanced features to be provided in a point-of-sale system.

Although advancements in card technology and transaction network technology provide the promise for applications with enhanced features, the promise has yet to be commercially realized due to the wide variety of point-of-sale systems, card readers and operating systems currently being employed. It would therefore be desirable to provide a transaction system that would include standardization through the use of a fixed data structure, thereby allowing multiple point-of-sale systems to recognize and access the smart cards regardless of upper level user interfaces.

### SUMMARY OF THE INVENTION

The invention provides a transaction system that includes standardization through the use of a fixed data structure that allows multiple point-of-sale systems to recognize and access a transaction card regardless of upper level user interfaces.

More specifically, a smart card including a memory with a defined set of data files or fields is provided, wherein the data structure includes at least one read only file or field, at least one encrypted read/write field, and at least one non-encrypted read/write field. The read only field preferably includes at least one of a manufacturer identification field, a card identification field and a theater identification field. The encrypted read/write field preferably includes at least one of a transaction log field, an issue date field, a first dollar value field, a second dollar value field, a first point value field, a second point value field and a ticket storage field. The non-encrypted read/write field preferably includes at least one of a first dollar value display field, a second dollar value display field, a first point value display field, a second point value display field and a user defined field.

The smart card is utilized in a transaction system the includes at least one smart card authorization device, a communication interface, and a transaction verification server. The smart card authorization device interacts with a defined data file structure provided on a smart card of the type described above.

An application program interface utilizes a predefined set of commands to control the reading and writing of data to the memory card based on the defined data structure. A mechanism is provided for encrypting and decrypting data read from and written to said encrypted data field on the fly. The predefined commands include a set of general commands, a set of read commands and a set of write commands.

The standardized fixed card file structure allows all point-of-sale systems to readily recognize, accept and reject a smart card, which insures cross platform interoperability. If a smart card is accepted, the point-of-sale system can communicate with the smart card regardless of the upper level user interface.

In a preferred theater application, all dollar values, point values and information files are read and written using the same mechanisms. By utilizing a theater identification for a specific chain or individual theater, the system can compare the theater identification to grant or deny access to the smart card. The use of non-encrypted display fields or files for dollar values and point values makes it unnecessary for card readers to carry the encryption and decryption algorithms.

Other features and advantages of the invention will become apparent from the following detailed description of the preferred embodiments of the invention.

### BRIEF DESCRIPTION OF THE DRAWINGS

The invention will be described in greater detail with reference to certain preferred embodiments thereof and the accompanying drawings, wherein:

FIG. 1 is a schematic block diagram of a basic transaction system in accordance with the present invention;

FIG. 2 is a representation of the architecture of the basic transaction system illustrated in FIG. 1;

FIG. 3 is a schematic block diagram of the basic transaction system including secure sign-on architecture;

FIG. 4 is a table illustrating a data file structure in accordance with the present invention;

FIG. 5 is a table illustrating general commands card reader commands in accordance with the present invention;

FIG. 6 is a table illustrating card read commands in accordance with the present invention; and

FIG. 7 is a table illustrating card write commands in accordance with the present invention.

### DETAILED DESCRIPTION OF THE PREFERRED EMBODIMENTS OF THE INVENTION

The invention will be described with reference to certain preferred embodiments including a point-of-sale (POS) system for use in movie theaters. It will be understood, however, that the invention is not limited to the specifically described application, but instead, may be applied to any transaction network system, card transaction system or alternative application.

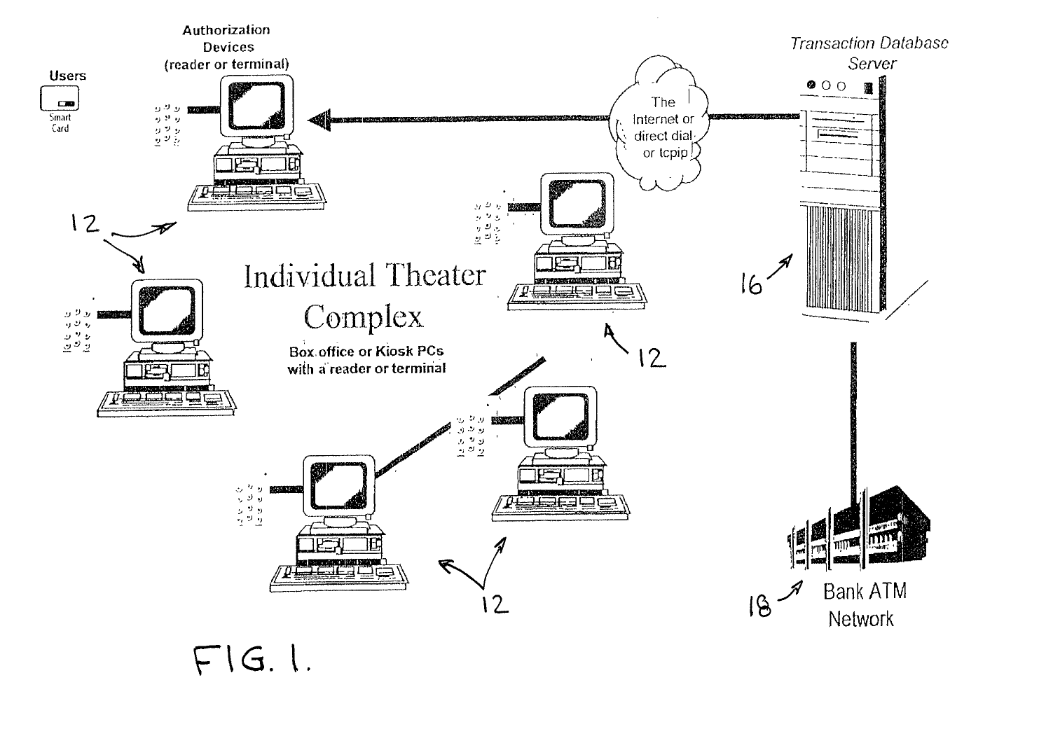

The basic components of a theater transaction system in accordance with the present invention is illustrated in FIG. 1. The transaction system includes a smart card 10, a plurality of authorization devices 12, for example a kiosk or computer terminal incorporating a smart card reader, a communication link 14 and a transaction database server 16 that communicates with the authorization devices 12 via the communication link 14. The transaction database server 16 may be coupled to other elements such as a bank ATM network 18 as illustrated in FIG. 1.

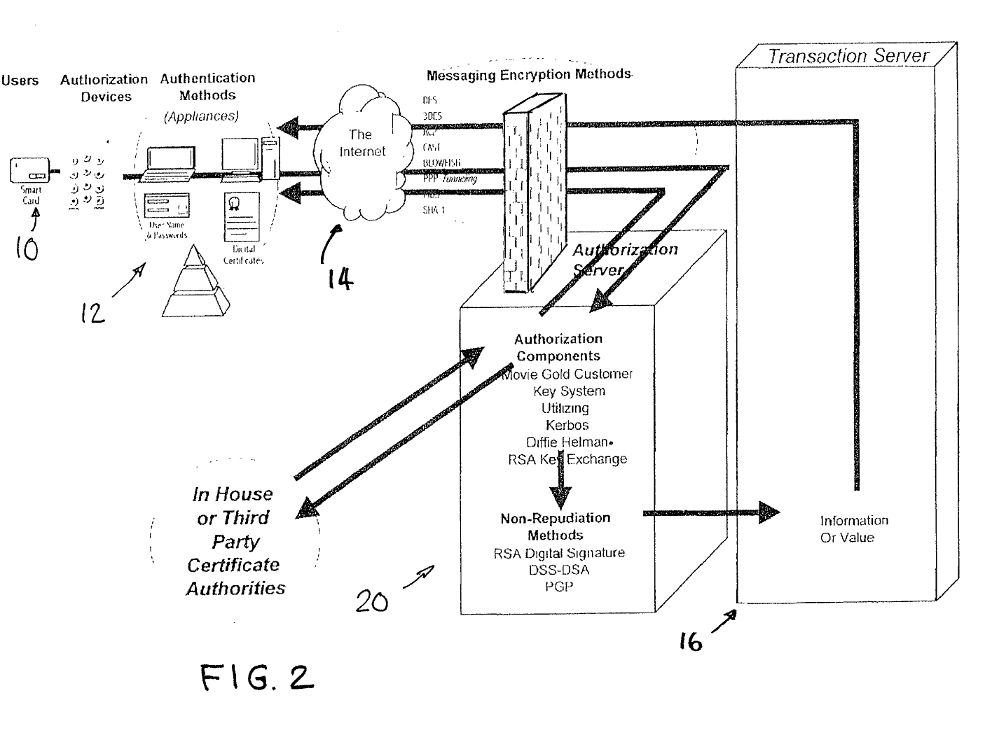

It is also desirable to provide for authorization prior to completion of transactions. FIG. 2 illustrates a secure sign-on architecture in which the authorization devices 12 interact with an authorization server 20 via the communication link 14. Transmission of data over the communication link 14 is preferably performed utilizing a conventional messaging encryption method. The authorization server 20 authorizes the transaction and provides notification to the transaction database server 16. The authorization server 20 may also be required to communicate with other in-house or third party authorities prior to authorizing the transaction.

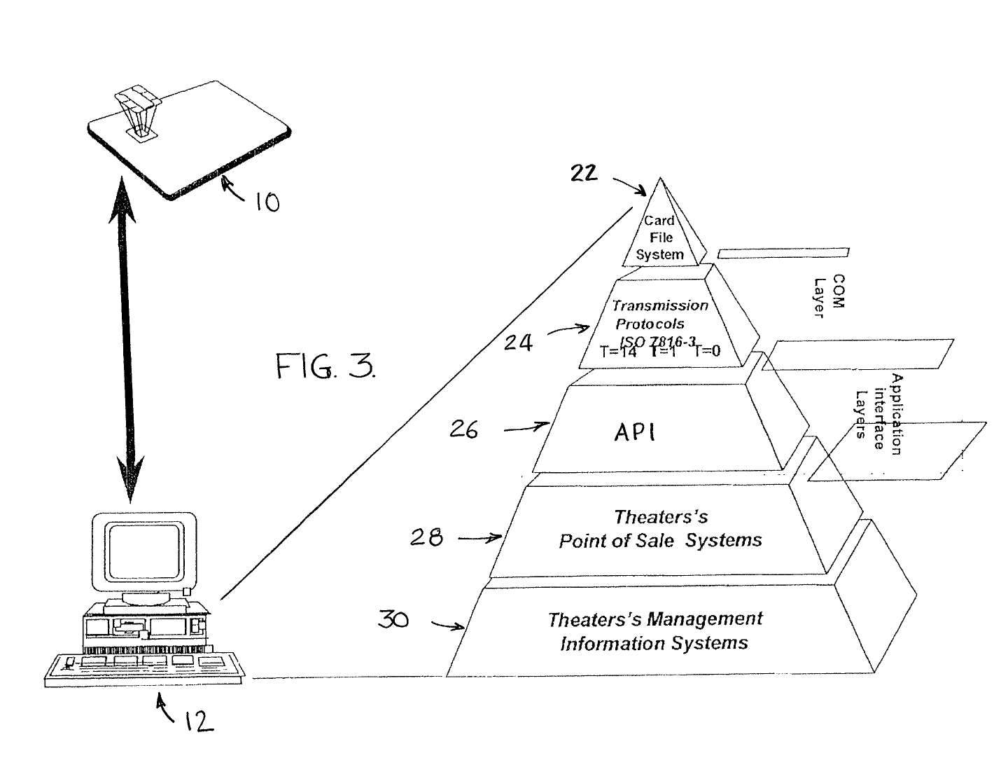

In actual practice, a company may have a variety of different types of authorization devices 12 incorporating different types of readers and different types of POS systems located at different theaters or theater chains. In order to make the smart card 10 useable in all circumstances, it is necessary to provide a low cost platform that can support all possible configurations. As illustrated in FIG. 3, this is accomplished by providing a fixed card file structure 22 on the smart card 10, a communication protocol 24 and an application program interface 26. The application program interface 26, referred to as “API” in the illustration, provides an interface between the card file structure 22 and the theater's established POS systems 28, which in turn interacts with the theater's management information systems 30. The interface is often referred to in the industry as middle ware. Depending upon the operating system and the developmental tools, this middle ware is referred to by different names, e.g., a DLL, an OCX, an APLET, or a LIBRARY file.

The card file structure 22 divides the memory of the smart card 10 into logical divisions as illustrated in FIG. 4, namely, a number of fields are provided some of which are read only and some of which are read/write. The read only fields include an ID field representing a manufacture's identification number, a CID field representing a card identification number, and a TID field representing a theater identification number. Several of the read/write fields are encrypted including a TL field representing a transaction log, a TD field representing an issue date, a VF1 field representing a first dollar value field, a VF2 field representing a second dollar value field, a PF1 field representing a first point value field, and a PF2 field representing a second point value field, and a TF field representing a ticket storage field. The remaining read/write fields include a VF1D field representing a first dollar field display field, a VF2D field representing a second dollar display field, a PF1D field representing a first point display field, a PF2D field representing a second point displauser defined field that can be parsed for popcorn, drinks, candy, first name, last name, address, city, state, zip code and telephone number. The dollar display fields and point display fields are preferably written to and updated at the same time as their corresponding encrypted data fields, and are provided to permit display of user information without comprising data integrity.

The application program interface 26 is based on a set of general commands and card specific commands to be utilized in connection with the operation of a card reader (for example, Axiohm 152a or Axiohm 171a) provided in the authorization devices 12. In discussing the general commands and card specific commands, a “reader handle” will be defined as a data item that is used to refer to the smart card reader and is used to store internal information about the smart card reader. A reader handle must be requested before accessing the smart card reader provided in the authorization device 12 or the smart card 10.

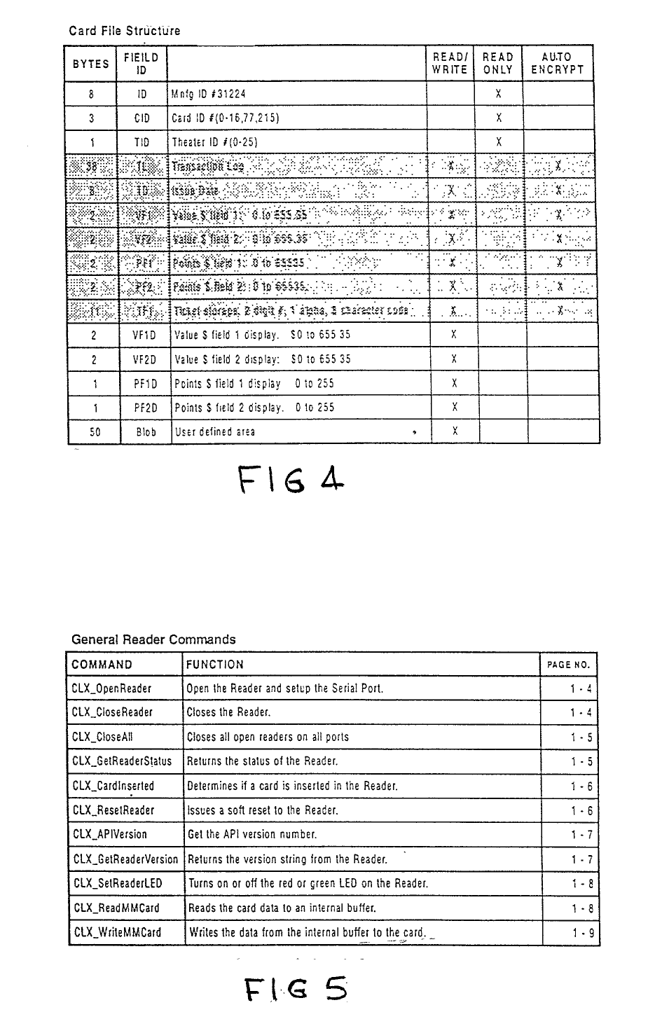

Referring now to FIG. 5, a set of general reader commands are illustrated that can be used on any card designed for this system. The general commands are used to set up the smart card reader provided in the authorization device 12, establish a connection between the card reader and a smart card 10, and return status information about the reader to the application program interface 26. The CLX_OpenReader command checks whether the card reader is connected to a specified serial port and that the baud rate specified is correct. If the command is successful, a reader handle is returned. If unsuccessful, a value is returned to define that the port is busy, an error opening the serial port occurred or the card reader is not responding. The CLX_CloseReader command closes the card reader on the port specified by the reader handle. The CLX_CloseAll command closes all open readers on all ports. The CLX_GetReaderStatus command returns the status of a reader. The CLX_CardInserted command determines if a card is inserted in the reader. The CLX_ResetReader command issues a soft reset to the card reader. The CLX_APIVersion command returns a six byte string that contains the version number of the application program interface 26. The CLX_GetReaderVersion command returns a version string from the card reader. The CLX_SetReaderLED command turns the card reader LEDs on or off.

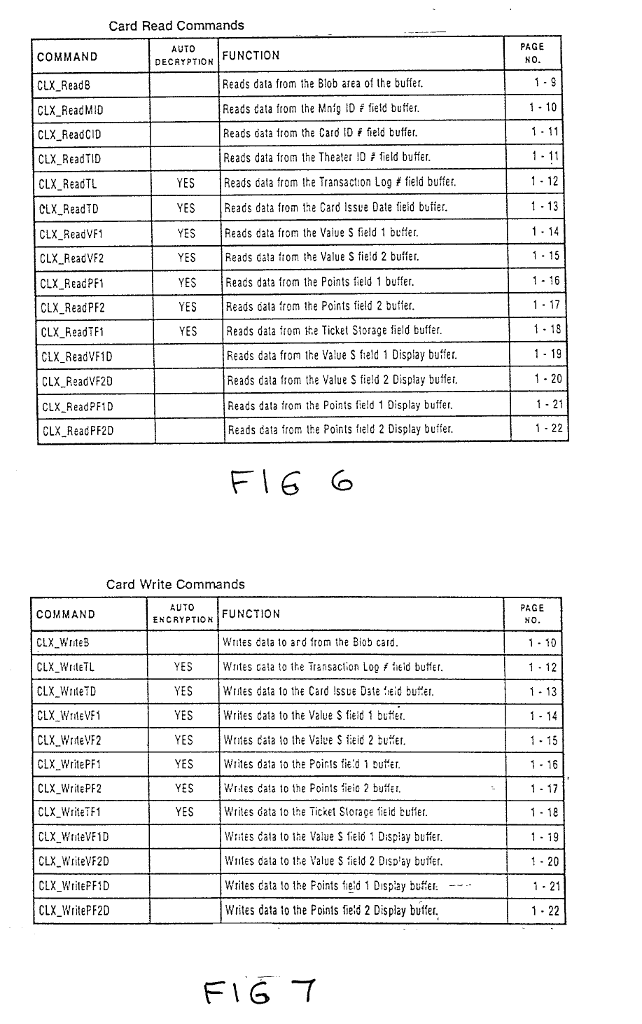

In addition to the general commands, a set of read command and write commands are provided. Data written to the smart card 10 is first written in a buffer prior to transfer. FIG. 6 illustrates a table including a preferred set of read commands. Similarly, write commands that correspond to the read commands are provided as shown in the table illustrated in FIG. 7.

As noted above, several of the data fields provided on the smart cards are encrypted. All encryption is preferably based on a variety of algorithms.

The standardized fixed card file structure allows all POS systems to readily recognize, accept and reject a smart card 10, which insures cross platform interoperability. If a smart card 10 is accepted, the POS system can communicate with the smart card 10 regardless of the upper level user interface. All dollar values, point values and information files are read and written using the same mechanisms. By utilizing a theater ID for a specific chain or individual theater, the system can compare the theater ID to grant or deny access to the smart card. The use of non-encrypted display fields for dollar values and point values makes it unnecessary for card readers to carry the encryption and decryption algorithms.

It is preferable that software developed in connection with the system be currently implemented with VB5.0, Delphi, and Visual C++ or greater in modular object oriented format to insure rapid issuer deployment of a card enhanced POS system. The target platform to run the software on will be a mix of Win 32 operating systems. The selection of any particular format or operating system will, of course, change depending on specific applications and future technological developments, and the invention is not limited to those specifically listed above.

The invention has been described with reference to certain preferred embodiments thereof. It will be understood, however, that modifications and variations are possible within the scope of the appended claims.

What is claimed is:

1. A smart card including a memory with a defined data file structure, said data file structure comprising:
at least one read only field;
at least one encrypted read/write field; and
at least one non-encrypted read/write field.

2. A smart card as claimed in claim 1, wherein the read only field includes at least one of a manufacturer identification field, a card identification field and a theater identification field.

3. A smart card as claimed in claim 1, wherein the encrypted read/write field includes at least one of a transaction log field, an issue date field, a first dollar value field, a second dollar value field, a first point value field, a second point value field and a ticket storage field.

4. A smart card as claimed in claim 1, wherein the non-encrypted read/write field includes at least one of a first dollar value display field, a second dollar value display field, a first point value display field, a second point value display field and a user defined field.

5. A transaction system including:
at least one smart card authorization device;
a communication interface; and
a transaction verification server;
wherein the smart card authorization device interacts with a defined data file structure provided on a smart card.

6. A transaction system as claimed in claim 5, wherein said data file structure comprises:
at least one read only field;
at least one encrypted read/write field; and
at least one non-encrypted read/write field.

7. A transaction system as claimed in claim 6, wherein the read only field includes at least one of a manufacturer identification field, a card identification field and a theater identification field.

8. A transaction system as claimed in claim 6, wherein the encrypted read/write field includes at least one of a transaction log field, an issue date field, a first dollar value field, a second dollar value field, a first point value field, a second point value field and a ticket storage field.

9. A transaction system as claimed in claim 6, wherein the non-encrypted read/write field includes at least one of a first dollar value display field, a second dollar value display field, a first point value display field, a second point value display field and a user defined field.

10. A transaction system comprising:
at least one smart card including a memory with a defined data structure, wherein said defined data structure includes at least one read only field, at least one encrypted read/write field, and at least one non-encrypted read/write field; and
read/write means for reading and writing data to the memory of the smart card, wherein said read/write means includes an application program interface that utilizes a predefined set of commands to control the reading and writing of data to the memory card based on the defined data structure.

11. A transaction system as claimed in claim 10, wherein the read only field includes at least one of a manufacturer identification field, a card identification field and a theater identification field.

12. A transaction system as claimed in claim 10, wherein the encrypted read/write field includes at least one of a transaction log field, an issue date field, a first dollar value field, a second dollar value field, a first point value field, a second point value field and a ticket storage field.

13. A transaction system as claimed in claim 10, wherein the non-encrypted read/write field includes at least one of a first dollar value display field, a second dollar value display field, a first point value display field, a second point value display field and a user defined field.

14. A transaction system as claimed in claim 10, wherein the read/write means further comprises means for encrypting and decrypting data read from and written to said encrypted data field.

15. A transaction system as claimed in claim 10, wherein the predefined commands include a set of general commands, a set of read commands and a set of write commands.
